(19) United States
(12) Patent Application Publication
(10) Pub. No.: US 2014/0140169 A1
(43) Pub. Date: May 22, 2014

(54) STEERABLE TOWED SIGNAL SOURCE

(71) Applicant: PGS GEOPHYSICAL AS, Lysaker (NO)

(72) Inventor: Guillaume Cambois, Oslo (NO)

(73) Assignee: PGS Geophysical AS, Lysaker (NO)

(21) Appl. No.: 13/682,397

(22) Filed: Nov. 20, 2012

(51) Int. Cl. G01V 1/38

(52) U.S. Cl. CPC G01V 1/3826
USPC 367/16

(57) ABSTRACT

Techniques are disclosed relating to steering a signal source towed behind a survey vessel. In one embodiment, a method includes towing a signal source and a streamer in a body of water. The signal source includes a steering mechanism. The method further includes determining a current heading of the streamer and, based on the determined heading, using the steering mechanism to adjust a heading of the signal source. In some embodiments, the method also includes determining a current heading of the signal source based on location information received from one or more location buoys coupled to the signal source, and, based on the determined heading of the signal source, using the steering mechanism to adjust the heading of the signal source. In one embodiment, the steering mechanism is used to align the heading of the signal source with the heading of the streamer.

### BACKGROUND

Marine seismic surveys may be used for oil and gas exploration in marine environments. One type of survey, a marine seismic survey, is based on the use of sound waves. In such a survey, a vessel may tow an acoustic source and a plurality of streamers along which a number of sound sensors (e.g., hydrophones) are located. Sound waves generated by the source may then be transmitted to the earth's crust and then reflected back and captured at the sensors. Sound waves received during a marine seismic survey may be analyzed to locate hydrocarbon-bearing geological structures, and thus determine where deposits of oil and natural gas may be located. In a similar fashion, marine electromagnetic (EM) surveys may be conducted using EM signals transmitted by a submerged antenna and detected by EM receivers.

### BRIEF DESCRIPTION OF THE DRAWINGS

FIG. 1 is a diagram illustrating one embodiment of an arrangement for conducting a marine geophysical survey using an array of towed submerged streamers.

FIG. 2 is a diagram illustrating one embodiment of a signal source coupled to a towing vessel.

FIG. 3 is a block diagram illustrating one embodiment of a control system for a signal source.

FIGS. 4A-C are diagrams illustrating an example of towing a signal source in a cross current.

FIG. 5 is a flow diagram illustrating one embodiment of a method for towing a signal source.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Various apparatus, units, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component.

### DETAILED DESCRIPTION

The present disclosure describes embodiments in which one or more steerable signal sources are towed behind a survey vessel in conjunction with one or more streamers. As used herein, a “signal source” is an apparatus that is configured to emit a signal (e.g., acoustic, electromagnetic, etc.) that is reflected from one or more underlying structures and then measured. As used herein, the term “streamer” refers to an apparatus that includes detectors, sensors, receivers, or other structures configured to measure the reflected signal (e.g., by using hydrophones, electrodes, etc. that are positioned along or in proximity to the streamer). As will be described below, in various embodiments, a signal source may include a steering mechanism that permits the signal source to be steered as a survey vessel tows it through the water. In one embodiment, the signal source may be steered in a manner that increases (and, in some embodiments, attempts to maximize) the signal strength (i.e., the signal-to-noise ratio) of the signal when it is received at a streamer. In some instances, improving the signal strength allows for more accurate survey data to be collected.

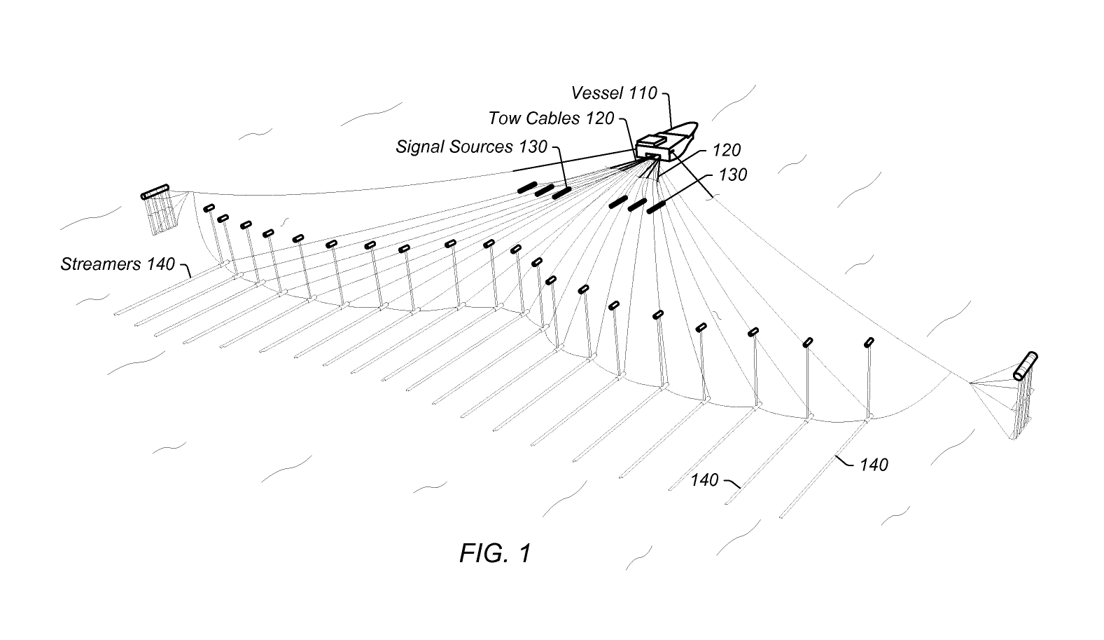

Turning now to FIG. 1, a diagram of an arrangement for conducting a marine geophysical survey using an array of towed signal sources is shown. In the embodiment shown, survey vessel 110 is towing an array of submergable signal sources 130 as well as an array of submergable streamers 140 that are coupled to vessel 110 via multiple tow cables 120.

Signal sources 130, in one embodiment, are configured to emit a set of signals measurable by detectors on streamers 140. Sources 130 may include a variety of seismic sources, such as marine vibrators or air guns. Accordingly, sources 130 may transmit sound waves into the water, the echoes of which may be detected by the seismic sensors of the streamers 140. Sources 130 may also include a variety of electromagnetic (EM) sources, such as antennas or magnetic coils. Accordingly, sources 130 may transmit EM signals into the water, which may be detected by the EM receivers of the streamers 140.

Detectors on streamers 140, in one embodiment, are configured to measure signals emitted by signal sources 130. In various embodiments, each streamer 140 may include a number of seismic sensors, EM receivers, or a combination thereof. The types of sensors that may be implemented in a given streamer include (but are not limited to) hydrophones and geophones. The types of receivers that may be implemented in a given streamer include (but are not limited to) electrodes and magnetometers. Moreover, a given streamer may include more than one type of sensor (e.g., a combination of hydrophones and geophones) or receiver (e.g., a combination of electrodes and magnetometers). Various operational considerations may make certain streamer towing depths advantageous. In some embodiments, single sensor streamers 140 may be towed at depths between about 4 meters and 30 meters. In some embodiments, dual sensor streamers may be towed at depths between 15 and 30 meters. In another embodiment, streamers may be towed at a much deeper depth of around 500 meters when implementing a “deep-tow” configuration. Although streamers 140 are depicted as being towed by vessel 110 in the illustrated embodiment, streamers 140 may be towed by a separate vessel than the vessel towing signal sources 130 in other embodiments. In some embodiments, streamers 140 may be implemented in a similar manner as the streamers described in U.S. Pat. No. 7,834,632 or U.S. Pat. No. 8,098,542.

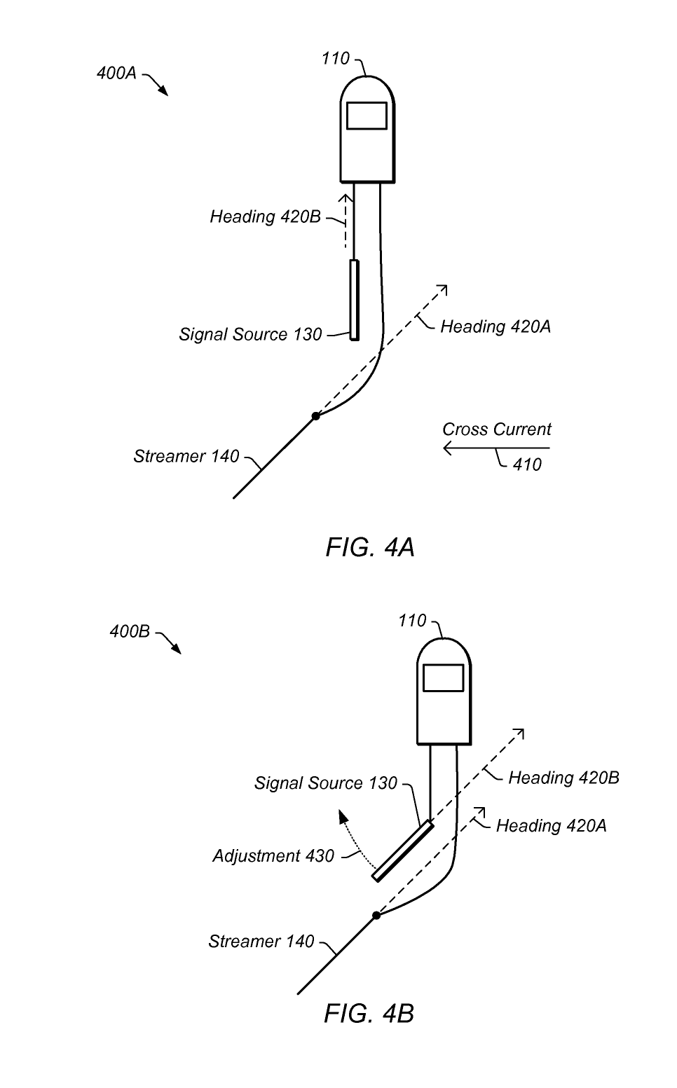

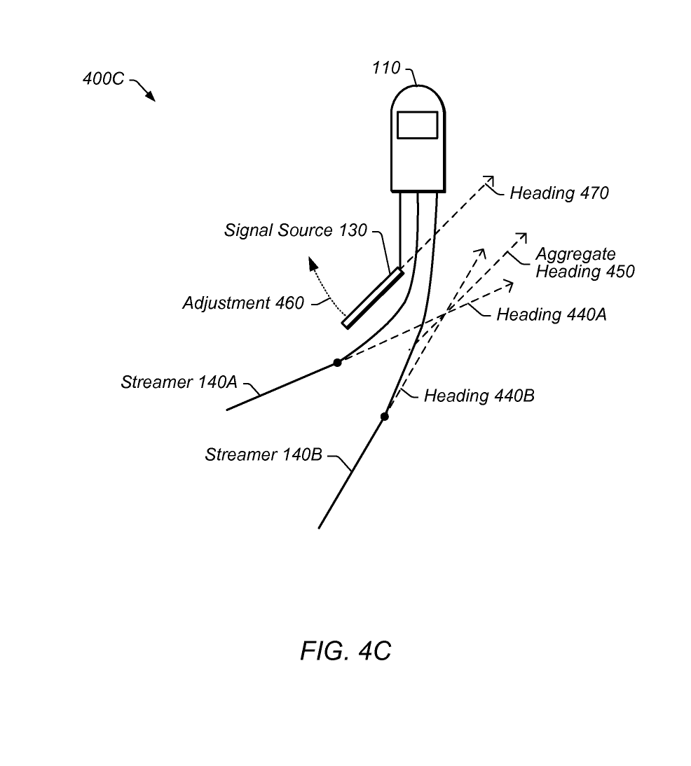

In some embodiments, the sensors and receivers of streamers 140 may be coupled to electronic equipment (referred to as “geophysical electronic equipment”) aboard tow vessel 110 that may be used to analyze geophysical data, such as received echoes or detected signals. For example, in one embodiment, vessel 110 may use this data to identify geological formations indicative of oil and/or natural gas deposits as part of a marine geophysical survey. In many instances, the accuracy of collected data from streamers may be affected by the signal-to-noise ratio (SNR) of the signals being measured by streamers 140. More specifically, a signal source 130 may emit a signal (e.g., an EM signal) for which the signal strength is strongest at the streamer 140 when the signal source 130 and the streamer 140 are aligned with one another—i.e., having the same heading. As used herein, the term “heading” refers to a direction of travel, and may be an apparent heading or a true heading. As used herein, an “apparent heading” refers to a direction in which an object (e.g., the bow of a boat) may be pointing, but is not necessarily the actual direction of travel (e.g., due to currents, crosswinds, etc.). As used herein, a “true heading” refers to the direction of actual travel relative to some reference. As such, any deviation from alignment may reduce the strength of a signal received at a streamer 140. Deviations may be caused, for example, by the presence of currents, which can induce feathering of streamers 140. Different currents may also affect signal sources 130 and streamers 140 as they may be towed at different depths. (An example illustrating how misalignment can occur is presented below with respect to FIG. 4A.)

In one embodiment, vessel 110 is configured to steer signal sources 130 and/or streamers 140 in a manner that maintains the alignment of signal sources 130 and streamers 140. For example, in some embodiments, each signal source 130 may be associated with a respective streamer 140. Vessel 110 may monitor the headings of the signal source 130 and the streamer 140 and adjust the heading of a signal source 130 if its heading and the heading of streamer 140 differ by more than a permissible tolerance (e.g., a tolerance of +/−2 degrees). In one embodiment, vessel 110 determines whether to adjust the heading of a signal source 130 based on the current heading of the streamer 140 and the current position of the signal source 130. With this information, vessel 110 can position the signal source 130 such that its heading matches the heading of streamer 140, thereby maximizing signal strength.

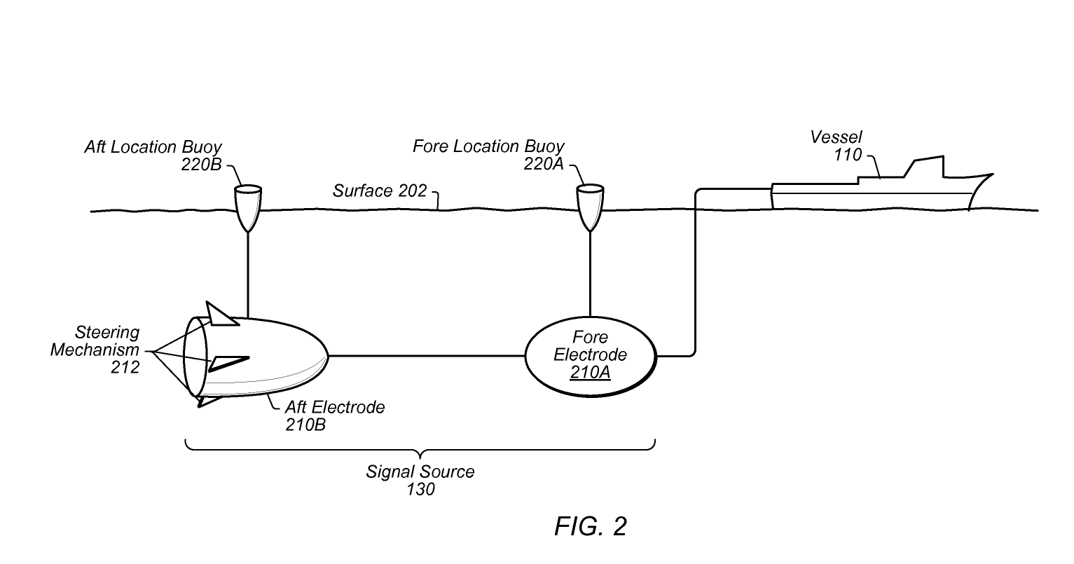

Vessel 110 may determine the locations and headings of signal sources 130 and streamers 140 using any of various techniques. As will be described with respect to FIG. 2, in one embodiment, a signal source 130 may include one or more location buoys to configured to provide location information usable to identify a location and a heading of the signal source. In one embodiment, the locations and headings of streamers 140 may be determined using an acoustic positioning system in which streamers 140 emit and monitor acoustic signals to determine their respective locations relative to one another and relative a set of tail buoys coupled to the ends of the streamers 140. In some embodiments, the acoustic position system may be implemented in a similar manner as the acoustic positioning system described in U.S. Pub. No. 2012/0230150.

Turning now to FIG. 2, a diagram of signal source 130 is depicted. As noted above, in some embodiments, signal sources 130 may be configured to use electrodes to emit an EM signal measurable by receivers on a streamer 140. In the illustrated embodiment, signal source 130 includes a fore electrode 210A and an aft electrode 210B, which are coupled to fore location buoy 220A and aft location buoy 220B, respectively. In addition, aft electrode 210B includes a steering mechanism 212. In some embodiments, signal source 130 may include additional electrodes 210, which may be coupled to additional respective buoys 220. In some embodiments, other electrodes (e.g., fore electrode 210) may also include a steering mechanism 212.

Steering mechanism 212, in one embodiment, is configured to control the heading of signal source 130 as it is towed through the water. In illustrated embodiment, steering mechanism 212 includes a set of adjustable fins coupled to electrode 210B. In some embodiments, the fins may be coupled to actuators that adjust the angles of the fins. In various embodiments, steering mechanism 212 provides lateral control for signal source 130, so that vessel 110 can steer signal source to port or starboard while maintaining a current depth. In some embodiments, steering mechanism 212 may also provide depth control, so that vessel 110 can lower and raise signal source 130.

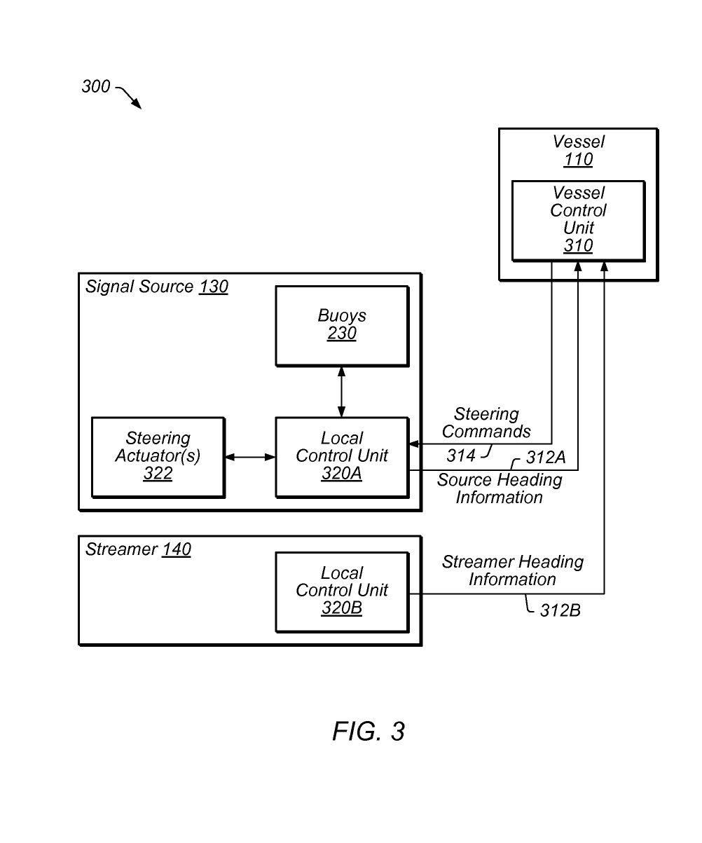

Location buoys 220, in one embodiment, are configured to provide current location information for a signal source 130. In various embodiments, buoys 220 may float at or near the water surface 202. In one embodiment, each buoy 220 includes a respective receiver for a satellite positioning system such as the Global Positioning System (GPS), the Global Navigation Satellite System (GLONASS), the Galileo System, etc. In another embodiment, buoys 220 may include receivers for a radio navigation system such as the Long Range Navigation (LORAN) system. In other embodiments, buoys 220 may employ other types of location systems. In some embodiments, location information from buoys 220 may be processed by a control system such as described next with respect to FIG. 3. In one embodiment, the control system determines the heading of signal source 130 based on the position of the fore electrode 210A (as identified by buoy 220A) and the position of the aft electrode 210B (as identified by buoy 220B).

Turning now to FIG. 3, a block diagram of a control system 300 is depicted. In the illustrated embodiment, control system 300 includes a vessel control unit 310 located within or proximate vessel 110, a local control unit 320A located within or proximate a signal source 130, and a local control unit 320B located within or proximate a streamer 140.

Vessel control unit 310, in one embodiment, is configured to control the steering of signal sources 130. In some embodiments, control unit 310 may perform additional operations such as collecting survey data measured by streamers 140, analyzing the data to render images associated with the underlying structures, etc. In some embodiments, control unit 310 may be integrated into vessel 110's navigation system such that the navigation system controls the steering of signal sources 130 and streamers 140 as well as the steering of vessel 110. In some embodiments, control unit 310 may be integrated into vessel 110's geophysical electronic equipment such that the steering of signal sources 130 and streamers 140 may respond to the geophysical data in near real time. In various embodiments, control unit 310 may perform various operations by executing program instructions with one or more processors of control unit 310, where the program instructions are stored within a computer readable medium of control unit 310. Generally speaking, a computer readable medium may include any non-transitory/tangible media readable by a computer system to provide instructions and/or data to the computer system. For example, a computer readable storage medium may include storage media such as magnetic or optical media, e.g., disk (fixed or removable), tape, CD, DVD, Blu-Ray, etc. Storage media may further include volatile or non-volatile memory media such as RAM, ROM, Flash memory, etc. Accordingly, in one embodiment, vessel control unit 310 may execute program instructions to receive source heading information 312A and streamer heading information 312B and to issue corresponding steering commands 314.

Heading information 312, in one embodiment, includes information that is usable by vessel control unit 310 to determine whether a heading of a signal source 130 should be adjusted. In various embodiments, heading information 312 includes location information of signal sources 130 and streamers 140. In one embodiment, this location information includes coordinate values such as latitude and longitude values. In some embodiments, this location information may include multiple location values for a given signal source 130 or streamer 140. For example, in one embodiment, local control unit 320A (which may be implemented using a microcontroller unit (MCU) having a processor and memory) may receive a location of each electrode 210 from buoys 220, and may convey this information as information 312A. Similarly, local control unit 320B (which also may be implemented using a microcontroller unit (MCU) having a processor and memory) may convey the locations of multiple sensors along a given streamer 140. In some embodiments, heading information 312 may also include the headings of signal sources 130 and/or streamers 140 as determined by local control units 320 based received location information; in other embodiments, headings may be determined by vessel control unit 310 based on received heading information 312. In various embodiments, heading information 312B may include heading information from multiple streamers 140 as discussed below.

Steering commands 314, in one embodiment, are issued by vessel control unit 310 to cause an adjustment of steering mechanism 212. In some embodiments, a given command 314 may specify adjustments as actuator settings for steering actuators 322 that operate steering mechanism 212. For example, in one embodiment, a command 314 may instruct an actuator 322 to adjust a fin to a specified angle. In another embodiment, a command 314 may specify a value of a desired heading for signal source 130. In such embodiment, local control unit 320A may be configured to adjust steering actuators 322 in real time based on information received from buoys 230 in order to achieve the desired heading. In some embodiments, local control unit 320A may make adjustments to actuators 322 to ensure that the heading of the signal source 130 remains within a permissible tolerance of the heading of streamer 140. For example, in one embodiment, this range of deviation may ensure that SNR of measured signals is above some minimal threshold. Accordingly, vessel control unit 310 may monitor the SNR of a signal measured by stream 140 and adjust the steering of signal source in response to detecting a deterioration in a signal quality of a signal (e.g., a drop below the minimal threshold). In some embodiments, vessel control unit 310 may also provide steering commands 314 to streamers 140 and/or to vessel 110 to align sources 130 and streamers 140. In some embodiments, vessel control 310 may determine a current respective heading for multiple streamers 140 towed an array and then determine an aggregate heading for the array. In various embodiments, the aggregate heading may be an average of the current headings, a weighted average, a mean, a median, etc. Vessel control 310 may issue commands 314 to signal source 130, ones of streamers 140, and/or vessel 110 based on this aggregate heading for the array.

An example illustrating the correction of a misalignment of a signal source 130 and one or more streamers 140 is discussed next with respect to FIGS. 4A-C.

Turning now to FIG. 4A, an example 400A of a misalignment of a signal source 130 and a streamer 140 is depicted. As shown, survey vessel 110 is towing signal source 130 and streamer 140 through a cross current 410. In some instances, current 410 may be a current that exists at a different (e.g., deeper) depth than the depth of signal source 130, so that it affects streamer 140 without affecting signal source 130. This is illustrated in example 400A with cross current 410 causing the streamer 140 to feather, changing its heading 420A to starboard. In doing so, the heading of streamer 140 is no longer aligned with the heading 420B of signal source 130. As a result, streamer 140 measures a weaker signal from signal source 130, which may result in less accurate survey data being collected in various embodiments.

Turning now to FIG. 4B, an example 400B of a correction of the misalignment is depicted. As shown, survey vessel 110 has applied a heading adjustment 430 to signal source 130 to align the heading 420B of signal source 130 with the heading 420A of streamer 140. (As noted above, in some embodiments, vessel 110 may also adjust the heading 420B of streamer 140.) In many instances such as the one shown, the headings 420A and 420B may not overlap; however, the headings 420 may be aligned such that they are parallel. In doing so, streamer 140 is able to receive a stronger signal emitted from signal source 130 even though the headings do not overlap one another.

Turning now to FIG. 4C, an example 400C of a correction of a misalignment between multiple streams 140 is depicted. As shown, steamers 140A and 140B may have different respective current headings 440A and 440B due to the various issues discussed above. In the illustrated embodiment, vessel 110 may determine an aggregate heading 450 for steamers 140 and apply an adjustment 460 based on this heading 450. In some embodiments, steamers 140 may also be steered to be more in line with heading 450.

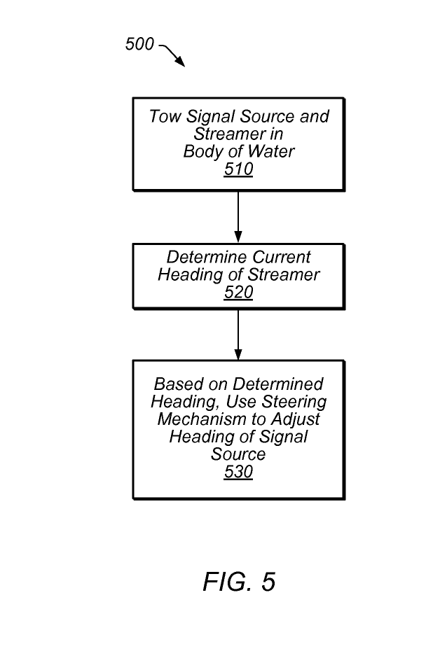

Turning now to FIG. 5, a flow diagram of a method 500 is depicted. Method 500 is one embodiment of a method that may be performed by a tow vessel such as vessel 110. In some embodiments, method 500 may be performed in conjunction with performance of a marine geophysical survey. In many instances, performance of method 500 may improve the accuracy of data collected during such a survey.

In step 510, a signal source (e.g., source 130) and a streamer (e.g., streamer 140) are towed in a body of water. In one embodiment, the signal source and the stream are towed by the same survey vessel; in another embodiment, they are towed by separate vessels. In one embodiment, the signal source is configured to generate an electromagnetic signal via a fore electrode (e.g., electrode 210A) and an aft electrode (e.g., electrode 210B). In some embodiments, the aft electrode includes a steering mechanism (e.g., mechanism 212) usable to control a heading of the signal source.

In step 520, a current heading of the streamer is determined. In one embodiment, this heading is determined using an acoustic positioning system such as the one described above. In some embodiments, step 520 further includes determining a current heading of the signal source. In one embodiment, this heading may be determined based on location information received from one or more location buoys (e.g., buoys 220) coupled to the signal source. In some embodiments, this location information includes one or more coordinates determined via a satellite position system. In one embodiment, the location information includes a first coordinate specifying a fore location of signal source (e.g., a location of fore electrode 210A) and a second coordinate specifying an aft location of the signal source (e.g., a location of aft electrode 210B). In some embodiments, step 520 includes determining a respective current heading for multiple streamers (e.g., each streamer within an array of towed streamers). In one embodiment, step 520 may further include determining an aggregate current heading for the streamer (such as discussed above) based on the determined respective headings.

In step 530, the steering mechanism of the signal source is used to adjust a heading of the signal source based on the heading (or headings) determined in step 520. In some embodiments, the steering includes steering the signal source in a manner that maximizes the signal strength of a signal being measure at the streamer. Accordingly, in one embodiment, the steering mechanism may be used to align the heading of the signal source with the heading of the streamer. In some embodiments, step 530 may further include steering one or more streamers and/or the towing vessel based on the determined headings in step 520. In one embodiment, step 530 may further include adjusting the steering of the signal source in response to detecting a deterioration in a signal quality of a signal measured by the streamer.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

1. A method, comprising:
towing a signal source and a streamer in a body of water, wherein the signal source includes a steering mechanism;
determining a current heading of the streamer; and
based on the determined heading of the streamer, using the steering mechanism to adjust a heading of the signal source.

2. The method of claim 1, wherein the signal source and the streamer are towed behind a single survey vessel.

3. The method of claim 1, further comprising:
towing a plurality of streamers as an array in the body of water;
determining a respective current heading for ones of the plurality of streamers in the array;
determining an aggregate current heading of the array based on the determined respective headings; and
based on the determined aggregate heading of the array, using the steering mechanism to adjust a heading of the signal source.

4. The method of claim 3, further comprising:
determining a current heading of the signal source based on location information received from one or more location buoys coupled to the signal source;
based on the determined heading of the signal source, using the steering mechanism to adjust the heading of the signal source; and
steering the array based on the determined heading of the signal source and the determined aggregate heading of the array.

5. The method of claim 1, wherein the signal source is configured to generate an electromagnetic signal via a fore electrode and an aft electrode, and wherein the steering mechanism is a steering mechanism of the aft electrode.

6. The method of claim 1, wherein said using includes using the steering mechanism to align the heading of the signal source with the heading of the streamer.

7. The method of claim 1, further comprising:
determining a current heading of the signal source based on location information received from one or more location buoys coupled to the signal source; and
based on the determined heading of the signal source, using the steering mechanism to adjust the heading of the signal source.

8. The method of claim 7, further comprising:
steering the streamer based on the determined heading of the signal source and the determined heading of the streamer.

9. The method of claim 1, wherein the location information includes one or more coordinates determined via a satellite position system.

10. The method of claim 1, wherein said determining includes using an acoustic positioning system to determine the current heading of the streamer.

11. An apparatus, comprising:
at least two electrodes configured to generate an electromagnetic signal;
one or more location buoys, wherein each location buoy is configured to determine location information of the apparatus; and
a steering mechanism configured to control a heading of the apparatus;
wherein the apparatus is towable behind a survey vessel in a body of water along with a streamer configured to measure a reflected version of the electromagnetic signal generated by the apparatus.

12. The apparatus of claim 11, wherein the apparatus is configured to:
provide, to the survey vessel, the location information determined by the one or more location buoys; and
receive, from the survey vessel, steering information usable to adjust the steering mechanism to control the heading of the apparatus.

13. The apparatus of claim 12, wherein the location information includes first and second coordinates, wherein the first coordinate specifies a fore location of the apparatus, and wherein the second coordinate specifies an aft location of the apparatus.

14. The apparatus of claim 12, wherein the location information includes a heading value specifying a current heading of the apparatus.

15. The apparatus of claim 12, wherein the steering information includes a desired heading for the apparatus, and wherein the apparatus is configured to adjust the steering mechanism to achieve the desired heading.

16. The apparatus of claim 11, wherein the location buoys are configured to determine the location information by accessing a satellite positioning system.

17. The apparatus of claim 11, wherein the steering mechanism is coupled to an aft-most one of the at least two electrodes.

18. A computer readable medium having program instructions stored therein, wherein the program instructions are executable by a computer system to cause the computer system to perform operations comprising:
receiving a first set of heading information from a signal source towed in a body of water;
receiving a second set of heading information from a streamer towed in the body of water; and
steering the signal source based on the first and second sets of heading information.

19. The computer readable medium of claim 18, wherein the first set of heading information includes a location of an aft electrode of the signal source and a location of a fore electrode of the signal source.

20. The computer readable medium of claim 19, wherein the locations are specified as coordinates having a respective latitude value and a respective longitude value.

21. The computer readable medium of claim 18, wherein the signal source is configured to emit a signal that is measured by the streamer, and wherein said steering includes steering the signal source in a manner that maximizes a signal strength of the signal at the streamer.

22. The computer readable medium of claim 18, wherein said steering includes providing steering commands to the steering mechanism of the signal source to cause an adjustment of a bearing of the signal source.

23. The computer readable medium of claim 18, wherein the computing system is a navigation system of the survey vessel, and wherein the operations further comprise adjusting a bearing of the survey vessel.

24. The computer readable medium of claim 18, wherein the operations further comprise:
determining an aggregate heading for a plurality of streamers towed as an array in the body of water; and
steering the signal source and one or more of the plurality of streamers based on the determined aggregate heading.

25. The computer readable medium of claim 18, wherein the operations further comprise:
detecting a deterioration in a signal quality of a signal measured by the streamer; and
adjusting the steering of the signal source in response to the detected deterioration.
